(19) United States
(12) Patent Application Publication
(10) Pub. No.: US 2009/0113706 A1
(43) Pub. Date: May 7, 2009

(54) Craze crack repair of combustor liners

(75) Inventors: Edward J. Emilianowicz, West Chester, OH (US); Warren M. Miglietti, Greenville, SC (US); Jere A. Johnson, Greenville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/979,588

(22) Filed: Nov. 6, 2007

(51) Int. Cl. B23P 6/00

(52) U.S. Cl. 29/888.011

(57) ABSTRACT

A method of repairing a turbine component with one or more craze cracks therein includes the steps of: (a) routing out the one or more cracks to form one or more routed areas; (b) applying a superalloy powder/paste in the one or more routed areas; (c) heat treating the component in place to form one or more repaired areas; and (d) blending the repaired area with adjacent areas of the component.

### BACKGROUND OF THE INVENTION

This invention relates generally to gas turbine combustion technology, and more specifically, to a method of repairing areas of craze cracking in hot gas path combustor components constructed of either Co-based or Ni-base superalloys.

In a gas turbine combustion system, the combustion chamber casing contains a liner, which is usually of an annular, tubular configuration, with a closed end and an opposite open end. Fuel is ordinarily introduced into the liner at or near the closed end, while compressor discharge air is admitted through circular rows of apertures or air mixing holes spaced axially along the liner. These gas turbine combustion liners may be made from Co- or Ni-based superalloys and usually operate at extremely high temperatures and depend to a large extent on the incoming combustion air from the compressor for liner cooling purposes. After periods of use, certain combustor liners experience areas of craze cracking that may even extend through the wall thickness of the liner. These areas are currently regarded as non-repairable if the craze cracking is severe and the liners are simply scrapped. If the level of craze-cracking is not severe, a weld repair is implemented; however, the distortion from the welding process requires complicated fixturing and careful control to ensure that the dimensions of the combustion liner are maintained.

### BRIEF DESCRIPTION OF THE INVENTION

In accordance with an exemplary non-limiting implementation of the technology disclosed herein, a new process has been developed that allows local areas of craze cracking in Co- or Ni-based superalloys to be mechanically removed and thereafter refilled with a superalloy powder than is similar in composition to that of the base metal being repaired. This repair method is economical and does not cause any significant distortion with respect to dimensional stability of the liner, as would be the case with a weld repair.

Accordingly, in one aspect, the present invention relates to a method of repairing a turbine component with one or more craze cracks therein comprising: (a) routing out the one or more cracks to form one or more routed areas; (b) applying a superalloy powder/paste of similar composition to the component being repaired in the one or more routed areas; (c) heat treating the component in place to form one or more repaired areas; and (d) blending the repaired area with adjacent areas of the component.

In another aspect, the invention relates to a method of repairing a turbine component with one or more craze cracks therein comprising: (a) routing out the one or more cracks to form one or more routed areas; (b) applying a superalloy powder/paste in the one or more routed areas; (c) heat treating the component by heating the component to about 1850° F. for about thirty minutes; raising the temperature to about 2100° F. for about thirty minutes; cooling the component to about 1975° F. and holding there for about four hours; raising the temperature to about 2050° F. for about four hours; and increasing the temperature to about 2100° F. for about two hours thus also simultaneously restoring the microstructure of the base metal being repaired; and (d) blending the repaired area flush with adjacent areas of the component.

The invention will now be described in greater detail in connection with the drawings identified below.

### BRIEF DESCRIPTION OF THE DRAWINGS

FIG. 1 is a side elevation view of a conventional gas turbine combustor liner;

FIG. 2 is a photograph of a craze-crack area on a combustion liner;

FIG. 3 is a photomicrograph of a craze-crack area on a combustion liner where the cracks have been blended and routed out;

FIG. 4 is an enlarged detail taken from FIG. 3; and

FIG. 5 is a photomicrograph of an area repaired by the disclosed method.

### DETAILED DESCRIPTION OF THE INVENTION

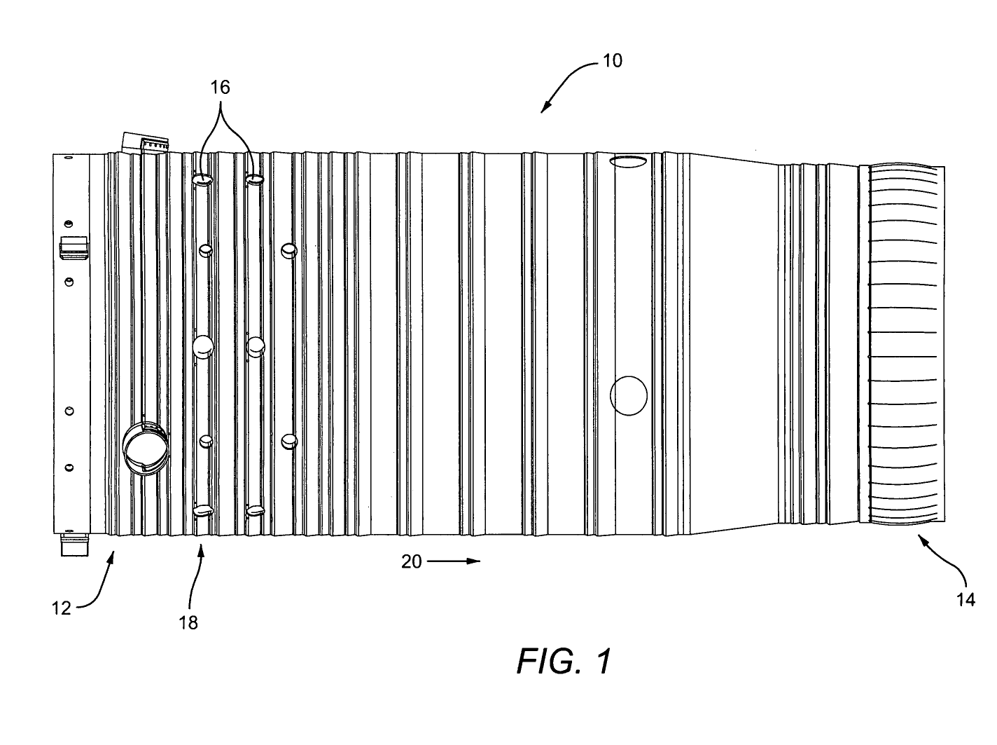

With initial reference to FIG. 1, a conventional Co- or Ni-based superalloy turbine combustor liner 10 includes a generally cylindrical body having a forward end 12 and an aft end 14. The forward end 12 is typically closed by liner cap hardware that also mounts one or more fuel injection nozzles for supplying fuel to the combustion chamber within the liner. The opposite end of the liner is typically secured to a tubular transition piece that supplies the hot combustion gases to the first stage of the turbine. As indicated above, compressor discharge air is supplied to the combustion chamber through a plurality of holes 16 in the liner.

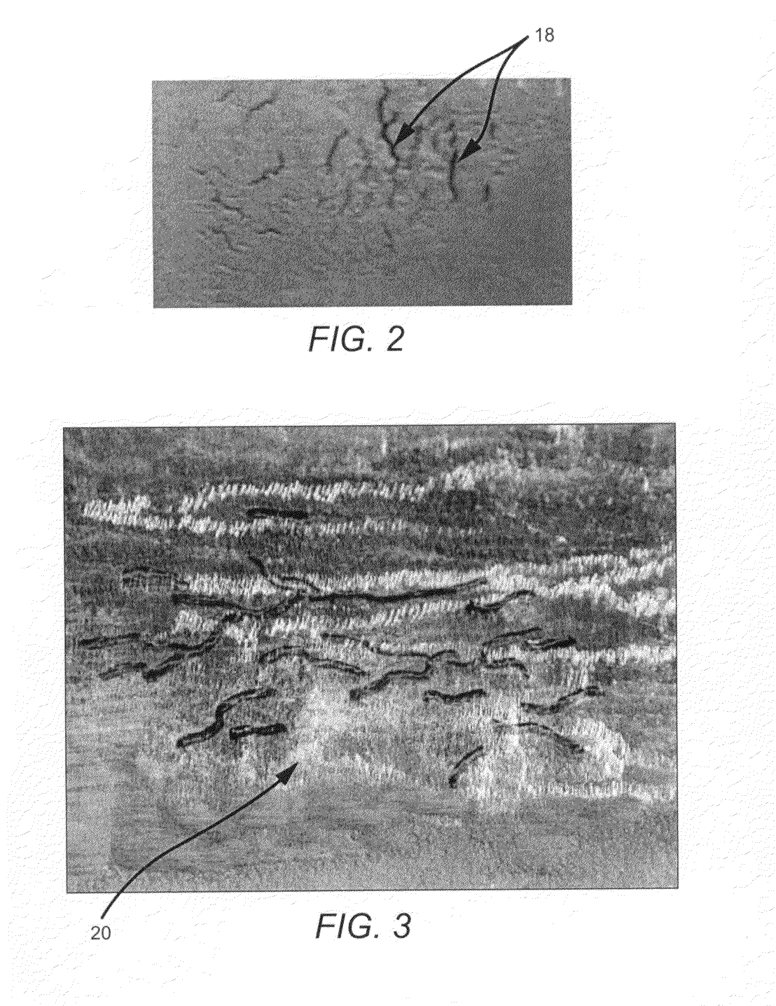

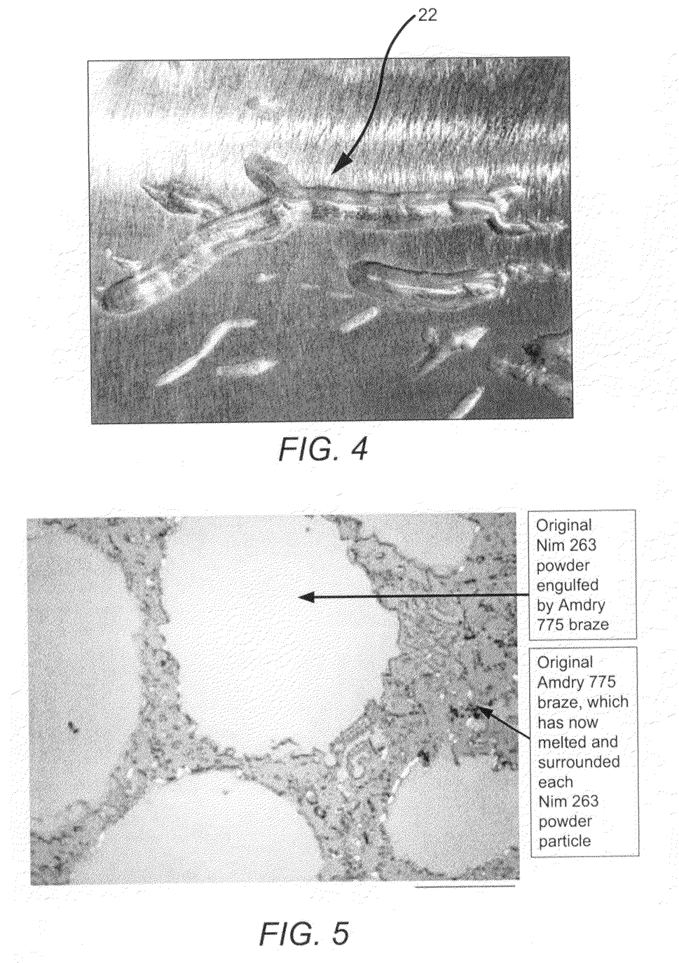

Turning to FIGS. 2 and 3, a craze crack area within the liner surface is illustrated at 18. Typically, craze cracking creates numerous, mostly surface cracks in a relatively small area, but it is possible that one or more of the cracks can extend through the thickness of the liner. In accordance with an exemplary implementation of the invention, the one or more individual craze cracked areas are first blended together where possible and routed out with a carbide burr tool, best seen at 20 in FIG. 3 and at 22 in FIG. 4. It will be appreciated that in this process, a portion of the thermal barrier coating (TBC) typically applied to combustor liners will be removed from the craze crack area.

After the cracks have been blended and routed out, the area is cleaned with a suitable chemical such as acetone. Thereafter, in a preferred arrangement, a liquid phase sintering process developed by the assignee of this invention is used to repair the craze crack area. Specifically, a commercially available Ni-based superalloy Nimonic 263 (a precipitation hardenable, high melt nickel-chromium-cobalt alloy), also referred to herein as N263, is applied in powder/paste form to the routed out cracks. This alloy is chosen to impart high strength properties to the repaired area. Amdry 775 (a commercial nickel-based brazing alloy—see U.S. Pat. No. 4,713,217) is then applied in, for example, slurry form to encapsulate the N263 powder in place. The component is then subjected to a heat treatment that will first braze or melt the Amdry 775 over the Nimonic 263, and then diffusion bond the Nimonic 263 to the component (see FIG. 4).

In an exemplary but non-limiting heat treatment process, the component is placed in a vacuum furnace (or a furnace back filled with Argon gas) with the Nimonic 263 and Amdry 775 in place, and heated to about 1850° F. (1850°±25° F.) for about thirty minutes (30±5 minutes). The temperature is subsequently raised to about 2100° F. (2100±25° F.) for about thirty minutes, effectively melting the Amdry 775 over the Nimonic 263. Thereafter, the component is allowed to cool to about 1975° F. (1975±25° F.) to solidify the melt and is held at this temp to start the diffusion bonding process. Following, the temperature is raised to about 2050° F. (2050±25° F.) for about four hours (4 hours±30 minutes) and then increased to about 2100° F. (2100° F.±25° F.) for about two more hours to thereby create an effective diffusion bond between the crack filler material and the liner. At this same time, the original combustion liner also goes through a full solution heat treatment, so that not only does the thermal cycles repair the cracks, but also rejuvenates or restores the base metal. The repaired area is finish-machined and the original TBC is restored in that area.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of repairing a turbine component with one or more craze cracks therein comprising:
(a) routing out the one or more cracks to form one or more routed areas;
(b) applying a superalloy powder/paste of similar composition to the component being repaired in the one or more routed areas;
(c) heat treating the component in place to form one or more repaired areas; and
(d) blending the repaired area with adjacent areas of the component.

2. The method of claim 1 wherein said superalloy powder/paste comprises a precipitation-hardenable nickel-chromium-cobalt alloy.

3. The method of claim 2 comprising adding a Nickel-based brazing alloy in slurry form over the superalloy powder/paste prior to step (c).

4. The method of claim 1 wherein step (c) is carried out in a vacuum furnace or a furnace back filled with argon gas.

5. The method of claim 1 wherein plural adjacent cracks are blended and routed out in step (a).

6. The method of claim 4 wherein step (c) comprises: heating the component to about 1850° F. for about thirty minutes; raising the temperature to about 2100° F. for about thirty minutes; cooling the component to about 1975° F. and holding at this temperature for about 4 hours; raising the temperature to about 2050° F. and holding at this temperature for about four hours; and
raising the temperature to about 2100° F. and holding at this temperature for about two hours.

7. A method of repairing a turbine component with one or more craze cracks therein comprising:
(a) routing out the one or more cracks to form one or more routed areas;
(b) applying a superalloy powder/paste in the one or more routed areas;
(c) heat treating the component by heating the component to about 1850° F. for about thirty minutes;
raising the temperature to about 2100° F. for about thirty minutes; cooling the component to about 1975° F. and holding there for about four hours; raising the temperature to about 2050° F. for about four hours; and increasing the temperature to about 2100° F. for about two hours thus also simultaneously restoring the microstructure of the base metal being repaired; and
(d) blending the repaired area flush with adjacent areas of the component.

8. The method of claim 7 wherein step (c) is carried out in a vacuum furnace or a furnace back filled with argon gas.

9. The method of claim 7 wherein plural adjacent cracks are blended and routed out in step (a).
